(19) United States
(12) Patent Application Publication
(10) Pub. No.: US 2014/0334783 A1
(43) Pub. Date: Nov. 13, 2014

(54) CONNECTOR MODULE HAVING A MOVEABLE OPTICAL CONNECTOR

(71) Applicants: George D. Megason, Spring, TX (US); Kevin B. Leigh, Houston, TX (US); Everett R. Salinas, Pasadena, TX (US)

(72) Inventors: George D. Megason, Spring, TX (US); Kevin B. Leigh, Houston, TX (US); Everett R. Salinas, Pasadena, TX (US)

(21) Appl. No.: 14/361,221

(22) PCT Filed: Jan. 6, 2012
(86) PCT No.: PCT/US2012/020442

§ 371 Date: May 28, 2014

(51) Int. Cl. G02B 6/42; G02B 6/43

(52) U.S. Cl. CPC G02B 6/4278; G02B 6/43
USPC 385/89; 385/88; 385/92; 29/428

(57) ABSTRACT

A connector module includes a module optical connector and an engagement member to engage with a device having a device optical connector. The engagement member upon engagement with the device is to cause movement of the module optical connector towards the device optical connector.

### BACKGROUND

Electronic components can be optically connected to each other to allow for communication of optical signals between the electronic components. For example, an electronic device having an optical connector can be connected to a backplane infrastructure that has a mating optical connector. Alternatively, electronic devices having respective optical connectors can be optically connected to each other.

### BRIEF DESCRIPTION OF THE DRAWINGS

Some embodiments are described with respect to the following figures:

FIG. 1A is a schematic, perspective view of a system having a rack into which electronic devices can be mounted for connection to a backplane infrastructure using connector modules according to some implementations;

FIG. 1B illustrates a portion of a backplane infrastructure having connector modules for engagement with electronic devices, in accordance with some implementations;

FIG. 2A is a perspective view of a connector module according to some implementations, for engagement with an optical connector of an electronic device;

FIG. 2B illustrates some of the components depicted in FIG. 2A;

FIGS. 3A-3B illustrate the engagement of a plunger of a connector module with an alignment feature of an electronic device, according to some implementations;

FIGS. 4A-4B illustrate alternative implementations of a connector module for engagement with an electronic device;

FIG. 5 illustrates a different view of a connector module that is to be engaged with an electronic device, where the connector module has a protection door according to some implementations;

FIG. 6 is a perspective view of the connector module and electronic device of FIG. 5, with the protection door opened, in accordance with some implementations;

FIGS. 7A-7D are top views illustrating engagement of an electronic device with a connector module, according to some implementations; and

FIG. 8 is a flow diagram of a process of assembling a connector module according to some implementations.

### DETAILED DESCRIPTION

Electronic devices, such as blade server devices, storage devices, communications devices, and so forth, can be mounted in a rack, which includes a frame and other support elements for holding the electronic devices. The rack provides receptacles into which the electronic devices can be inserted. The rack can also include a backplane infrastructure for connection to the electronic devices that have been inserted into the rack. Generally, the backplane infrastructure can include a support structure to which connectors are attached. When electronic devices are mounted in the rack, connectors on the electronic devices can mate with connectors of the backplane infrastructure. The connectors of the backplane infrastructure are connected to communications media (e.g. optical fibers, electrical wires, etc.) to allow for communication with the electronic devices.

In some implementations, the backplane infrastructure can include optical connectors for optical connection with respective optical connectors of the electronic devices. It is noted that the electronic devices and the backplane infrastructure can also include electrical connectors for electrically connecting the electronic devices to the backplane infrastructure. In the ensuing discussion, reference is made to just optical connectors—note, however, that it is to be understood that various components discussed below can also additionally include electrical connectors.

In addition, although reference is made to connecting electronic devices to a backplane infrastructure, it is noted that techniques or mechanisms according to various implementations can also be applied to connecting electronic devices to each other.

The optical connection between an electronic device and the backplane infrastructure can include a blind-mate optical connection. A “blind-mate optical connection” refers to an optical connection in which one connector can be connected to another connector, with alignment between the connectors being automatically performed using alignment features, such that a user does not have to visually align connectors to make the connection.

In some arrangements, when a user inserts an electronic device into a receptacle of a rack for blind-mating with a corresponding optical connector of the backplane infrastructure, the applied insertion force and/or insertion speed can be relatively large. As a result, optical connectors can mate with relatively large force and/or at a relatively high mating speed. The relatively large force and/or relatively high mating speed can result in damage to or dislocation of optical elements of the optical connectors, which can prevent proper operation of the optical connectors.

In accordance with some implementations, a connector module is provided that has a dampener to control the rate of movement of an optical connector such that the engagement of two mating optical connectors is accomplished in a controlled manner, which reduces the likelihood of damage to or dislocation of optical elements of the optical connectors.

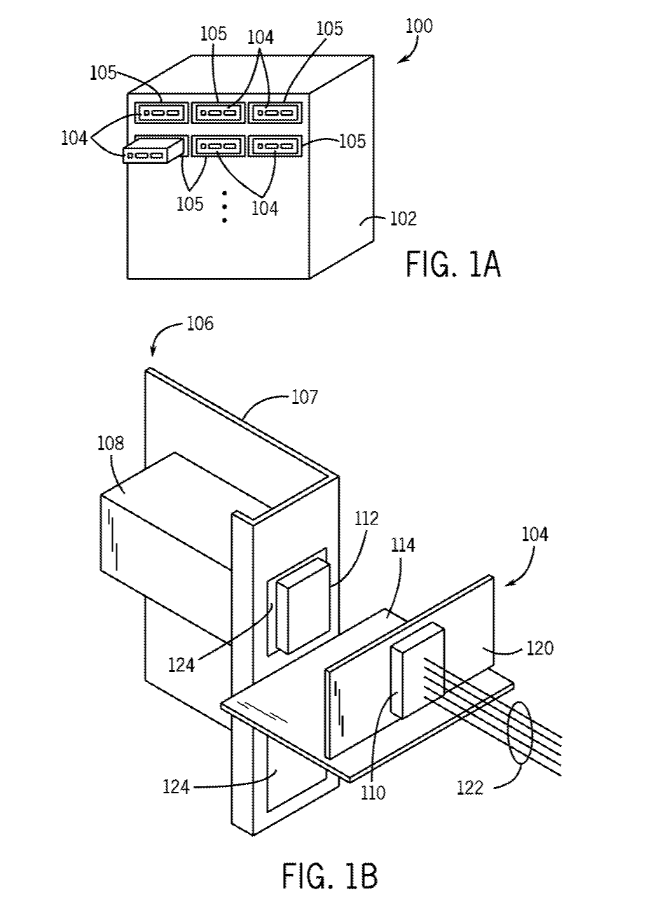

FIG. 1A illustrates an example system 100 that has a rack 102 that includes various electronic devices 104. The rack 102 includes an external chassis (or frame) defining receptacles 105 into which respective electronic devices 104 can be inserted. Although not shown in FIG. 1A, the rear portion of the rack 102 includes a backplane infrastructure having connectors to which the electronic devices 104 can be mated.

FIG. 1B is a schematic side view of a portion of the system 100 (with the external chassis omitted from the view of FIG. 1B), which includes a backplane infrastructure 106 that has a support structure 107 to which various connector modules 108 (just one shown in FIG. 1B) are attached. The connector modules 108 can be attached to the support structure 107 using any of various different types of attachment mechanisms, such as with screws, fasteners, and so forth.

Each connector module 108 includes an optical connector 112 for engaging with a respective optical connector 110 of the corresponding electronic device 104. In FIG. 1B, just the rear housing section 120, optical connector 110, and various optical cables (e.g. optical fibers 122) of the electronic device 104 are shown. As discussed further below, the optical connector 112 in the connector module 108 is retracted inside the housing of the connector module 108 until the electronic device 104 engages with the connector module 108, which causes the optical connector 112 in the connector module 108 to extend outwardly from the connector module housing through a corresponding opening 124 of a front section of the support structure 107 to connect to the optical connector 110 of the electronic device 104. Note that FIG. 1B shows the optical connector 112 of the connector module 108 in its extended position even though the electronic device 104 is not yet engaged with the connector module 108—this depiction is to allow a better view of the connector module optical connector 112 in its extended position. The retracted state and extended state of the optical connector 112 of the connector module 108 are shown in greater detail in various drawings discussed below.

The optical connector 112 of the connector module 108 is retracted inside the housing of the connector module 108 when not connected to an electronic device 104 to protect against dust or other particles collecting on optical elements of the optical connector 112, which can interfere with proper communication of optical signals. Retraction of the optical connector 112 inside the housing of the connector module 108 also provides mechanical protection for the optical connector 112 when not in use.

FIG. 1B also shows a support tray 114 (which is part of the rack 102) to support the electronic device 104 when the electronic device 104 is inserted into the receptacle 105 of the rack 102. The electronic device 104 is able to slide along the support tray 114 until the optical connector 110 of the electronic device 104 engages with the optical connector 112 of the connector module 108. Multiple support trays 114 are provided for guiding respective electronic devices 104. In other examples, instead of using support trays 114, other mounting features can be used, such as rails, grooves, and so forth.

In different examples, other arrangements of the backplane infrastructure 106 can be employed. Also, even though FIG. 1B shows the connector module 108 being attached to the support structure 107 of the backplane infrastructure 106, the connector module 108 can alternatively be connected to or be part of another electronic device to allow for optical connection with the electronic device 104.

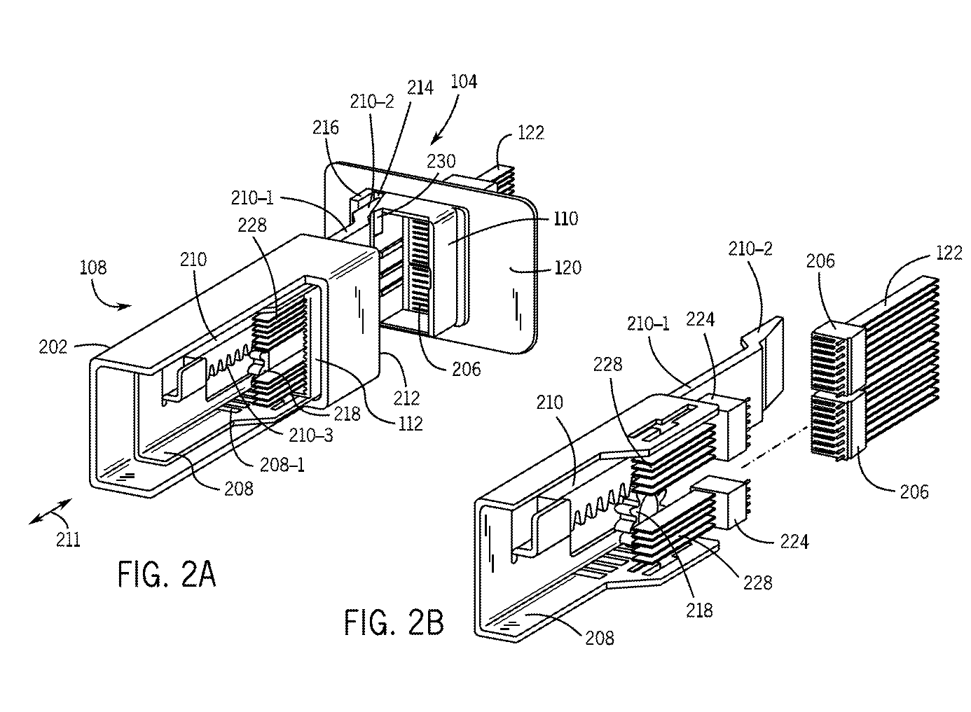

FIG. 2A is a perspective view of an example connector module 108 and a rear portion of an example electronic device 104. The connector module 108 has a housing 202 in which various components are contained.

In the ensuing discussion, the optical connector 110 of the electronic device 104 is referred to as a “device optical connector,” while the optical connector 112 of the connector module 108 is referred to as a “module optical connector.” According to further examples, the module optical connector 112 can be considered to be part of an electronic device 104, while the device optical connector 110 is part of a backplane infrastructure.

The device optical connector 110 has various optical elements 206, in the form of ferrules, which can perform optical communication with respective optical elements of the module optical connector 112 in the connector module 108. Generally, a “ferrule” of an optical connector refers to an interface for an optical fiber, where the interface allows for optical communication between the optical fiber and another optical component.

As further shown in FIG. 2A, the connector module 108 has a moveable carrier 208, which in some examples is slideable along a longitudinal axis (longitudinal direction) 211 of the connector module 108. The connector module 108 also has a plunger 210 that is also slideable along the longitudinal direction 211.

The plunger 210 has a portion 210-1 that protrudes outwardly from a front end 212 of the connector module housing 202. The protruding portion 210-1 has an engagement member 210-2, which is arranged to engage an alignment profile 214 of an alignment feature 216 that is part of the electronic device 104. In examples according to FIG. 2A, the alignment feature 216 is part of the device optical connector 110. In other examples, the alignment feature 216 can be separate from the device optical connector 110, but the alignment feature 216 can be mounted to the rear housing section 120 of the electronic device 104. The engagement profile 214 can be a groove or slot to receive the engagement member 210-2 of the plunger 210. In other implementations, the alignment feature 216 can have other configurations, or the alignment feature 216 can be omitted.

The alignment feature 216 is an example of an actuation feature of the electronic device 104 that is able to engage the plunger engagement member 210-2 to cause actuation (movement) of the module optical connector 112, as discussed below. In other examples, the electronic device 104 can have another type of actuation feature, such as the rear housing section 120 or other feature.

Insertion of the electronic device 104 into a receptacle 105 of the rack 102 (FIG. 1A) brings the alignment feature 216 into contact with the engagement member 210-2 of the plunger 210 of the connector module 108, as shown in FIG. 2A. When the engagement member 210-2 of the plunger 210 is engaged with the alignment feature 216, further movement of the electronic device 104 towards the connector module 108 causes movement of the protruding portion 210-1 of the plunger 210 into the connector module housing 202 along the longitudinal direction 211. Although reference is made to horizontal movement of the plunger 210 in the longitudinal direction 211 due to engagement with the alignment feature 216, note that in other examples the plunger 210 can exhibit different types of movement, such as vertical movement.

In examples according to FIG. 2A, the plunger 210 has a teeth profile 210-3 on one side of the plunger 210. A rotatable gear 218, also provided inside the connector module housing 202, has cogs to engage the teeth profile 210-3, such that sliding movement of the plunger 210 causes rotation of the rotatable gear 218.

The moveable carrier 208 also has profiles 208-1 that are engageable by the cogs of the gear 218. Rotation of the gear 218 causes corresponding sliding movement of the moveable carrier 208 in the longitudinal direction 211. The arrangement of the assembly of the plunger 210, gear 218, and moveable carrier 208 is such that longitudinal movement of the plunger 210 in a first direction causes a moveable carrier 208 to move in a second, opposite direction.

In examples according to FIG. 2A, the module optical connector 112 is mounted to the moveable carrier 208, such that sliding movement of the moveable carrier 208 causes a corresponding sliding movement of the module optical connector 112. In other implementations, instead of the module optical connector 112 being mounted to the moveable carrier 208, the module optical connector 112 can be coupled to the moveable carrier 208 using a different mechanism. More generally, the module optical connector 112 is coupled to the moveable carrier 208 such that movement of the moveable carrier 208 causes corresponding movement of the module optical connector 112.

The rotatable gear 218 is an example of a dampener to control the mating speed of the optical connectors 110 and 112. The gear 218 is pivotably mounted to the connector module housing 202. This pivotal mounting can be implemented using a screw, bolt, or other attachment mechanism. Friction between one side of the gear 218 and the inner wall of the connector module housing 202 provides a frictional force that has to be overcome to cause rotation of the gear 218. This frictional force controls the sliding movement of the plunger 210 and the moveable carrier 208. In other examples, instead of using frictional force between the gear 218 and the wall of the connector module housing 202, the frictional force can be provided by the attachment mechanism that attaches the gear 218 to the connector module housing 202. As yet another example, the gear 218 can have one portion that is frictionally engaged with another portion, such that the frictional force is provided within the gear 218 itself.

In accordance with some implementations, even if a user were to insert an electronic device 104 with relatively large force at a relatively rapid rate into the rack 102 of FIG. 1A, the presence of the dampener, such as the gear 218, controls the movement of the module optical connector 112, which allows for reduced mating speed of the optical connectors 110 and 112.

In other examples, a frictional layer can be provided between the gear 218 and the inner wall of the connector module housing 202 to provide additional frictional force that has to be overcome to move the module optical connector 112. In further implementations, instead of using the gear 218, the dampener can be implemented with a different mechanism, such as a mechanism that includes a spring. The spring can provide a biasing force to bias the module optical connector 112 in the retracted position inside the module connector housing 202. When the electronic device 104 is engaged with the plunger 210, a force would have to be provided to overcome the biasing force of the spring to cause outward movement of the module optical connector 112.

In operation, once the engagement member 210-2 of the plunger 210 is engaged to the alignment feature 216 of the electronic device 104, further movement of the electronic device 104 towards the connector module 108 causes corresponding sliding movement of the plunger 210 into the connector module housing 202. This movement of the plunger 210 causes rotation of the gear 218 in a counterclockwise direction, which in turn causes the moveable carrier 208 to move towards the front end 212 of the connector module 108. The movements of the plunger 210 and moveable carrier 208 are controlled by the gear 218 (or other dampener). As a result, the module optical connector 112 is correspondingly moved towards the device optical connector 110. Continued movement of the electronic device 104 towards the connector module 108 causes the optical connectors 113 and 112 to come into engagement.

FIG. 2B illustrates various components of FIG. 2A, but with the following components omitted: connector module housing 202, outer housing of the module optical connector 112, outer housing of the device optical connector 110, and the rear housing section 120 of the electronic device 104. In the view of FIG. 2B, clusters of ferrules 206 of the device optical connector 110 and clusters of ferrules 224 of the module optical connector 112 are shown. The ferrule clusters 206 and 224 are connected to respective optical cables 122 and 228, respectively. In the view of FIG. 2B, some of the ferrules 224 and respective optical fibers are omitted to allow a larger part of the gear 218 to be seen.

Since the mating speed of the optical connectors 110 and 112 can be controlled using a dampener, independent alignment features do not have to be provided for the individual ferrule clusters 206 and 224 of the optical connectors 110 and 112, respectively, which can allow for denser arrangements of the ferrules.

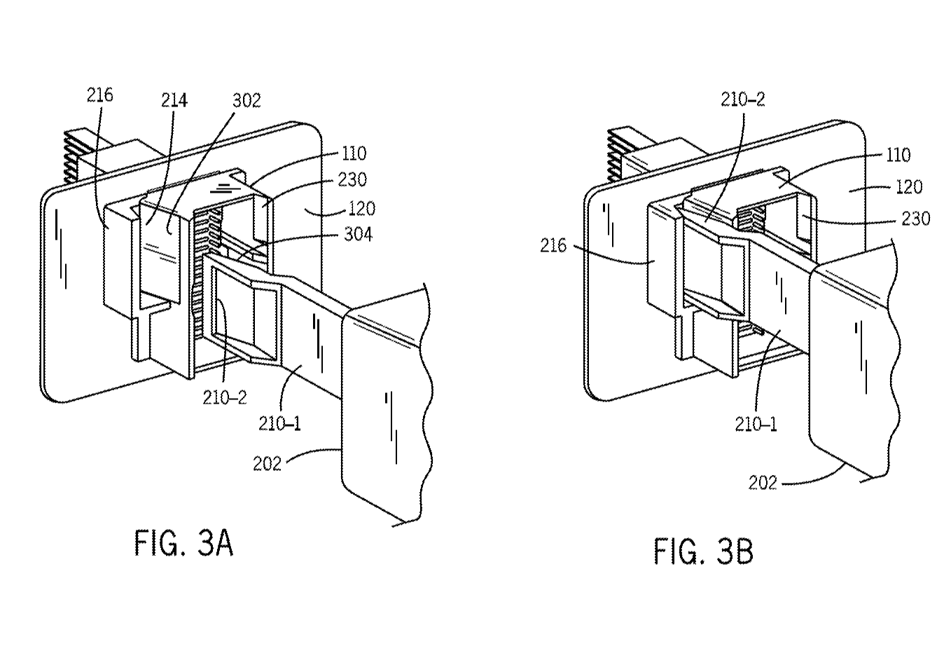

FIG. 3A illustrates the engagement member 210-2 of the plunger 210 before engagement with the alignment groove 214 of the alignment feature 216. Note that the alignment groove 214 is defined by a chamfer 302 (having a beveled or slanted face) that is also part of the alignment feature 216. The chamfer 302 is engageable to a corresponding chamfer 304 of the plunger engagement member 210-2. The chamfers 302 and 304 allow for relatively coarse alignment of the device optical connector 110 with the module optical connector 112. FIG. 3B shows the engagement member 210-2 engaged in the alignment groove 214.

In some examples, the device optical connector 110 depicted in FIGS. 3A and 3B can also be provided with an additional alignment feature, such as one or multiple slanted surfaces 230 provided inside the housing of the device optical connector 110. The slanted surface(s) 230 inside the housing of the device optical connector 110 allows for further alignment as the device optical connector 110 mates with the module optical connector 112. Although not depicted, the module optical connector 112 can include a corresponding feature(s) to engage with the slanted surface(s) 230 to provide alignment.

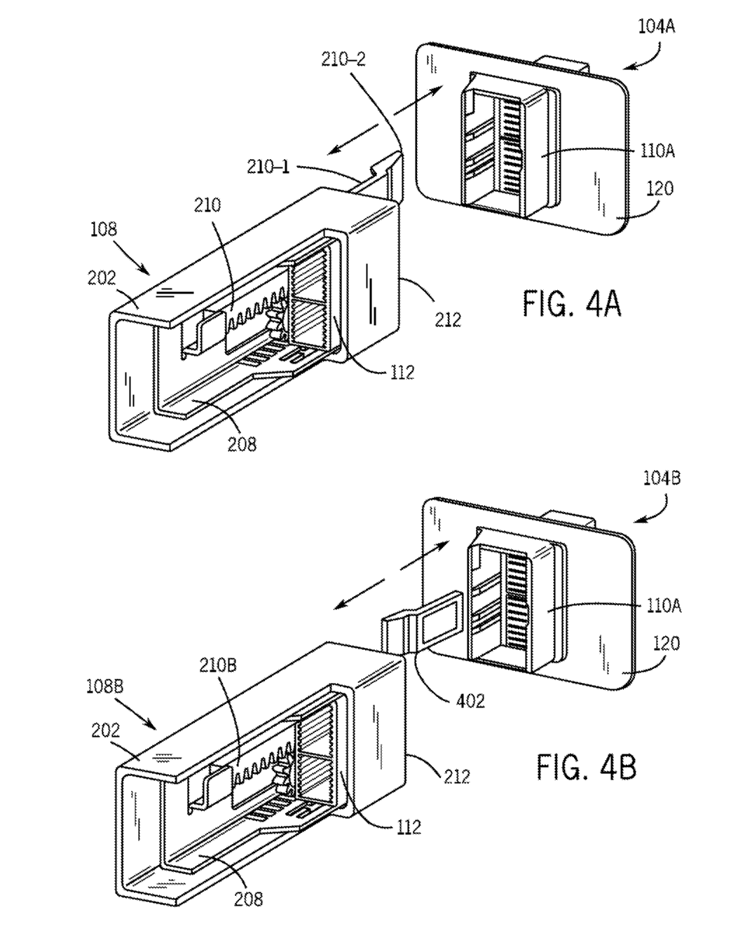

FIG. 4A is a perspective view of an arrangement according to alternative implementations. The connector module 108 of FIG. 4A is the same as the connector module 108 of FIG. 2A, However, a device optical connector 110A of an electronic device 104A (of FIG. 4A) is different from the device optical connector 110 of FIG. 2A. A difference is that the device optical connector 110A does not have the alignment feature 216 that is shown in FIG. 2A. In examples according to FIG. 4A, the engagement member 210-2 of the plunger 210 engages a surface of the rear housing section 120 of the electronic device 104A when the electronic device 104A is brought into engagement with the engagement member 210-2.

FIG. 4B shows an arrangement according to further alternative implementations, in which a modified connector module 108B has a plunger 210B without the protruding portion 210-1 shown in FIG. 2A. Instead, a protruding engagement member 402 is attached to the rear housing section 120 of an electronic device 104B of FIG. 4B. When the electronic device 1048 is moved towards the connector module 108B of FIG. 4B, the engagement member 402 of the electronic device 104B is brought into engagement with a corresponding profile of the plunger 210B to cause sliding movement of the plunger 210B in similar fashion as discussed above in connection with FIG. 2A. This causes corresponding rotation of the gear 218 and movement of the moveable carrier 208 to cause the module optical connector 112 to protrude from the front end 212 of the connector module 108B.

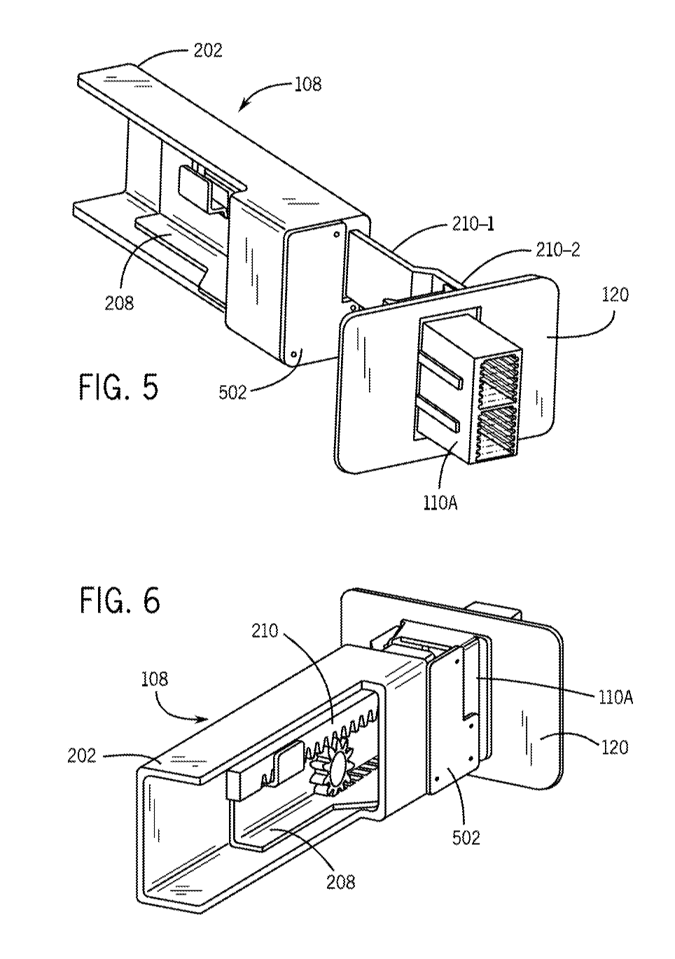

FIG. 5 shows a further feature of the connector module 108 according to some implementations. The connector module 108 has a protection door 502 that is actuatable between an open position and a closed position. The protection door 502 is closed when the device optical connector 110 of the electronic device 104 is not engaged with the module optical connector 112 of the connector module 108. The protection door 502 is used to protect the optical elements of the module optical connector 112 from dust or other particles.

FIG. 6 shows the protection door 502 in an pen position once the optical connectors 110 and 112 are engaged.

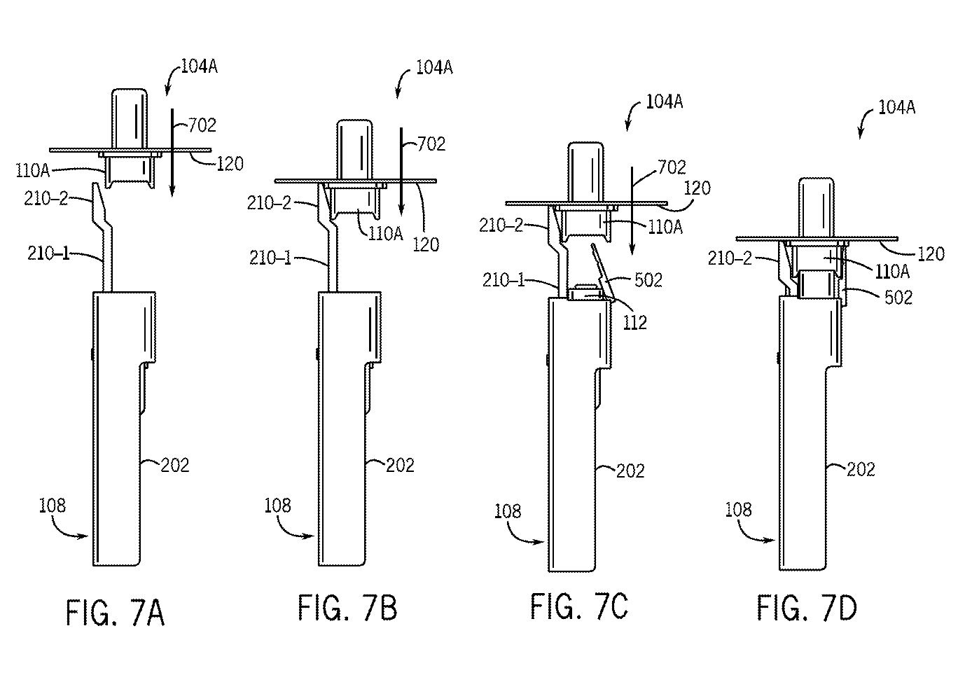

FIG. 7A-7D illustrate an example operation for connecting the electronic device 104A to the connector module 108. As shown in FIG. 7A, the electronic device 104A is moved in the direction indicated by arrow 702 towards the connector module 108. FIG. 7B illustrates initial engagement of the engagement member 210-2 of the plunger 210 with the rear housing section 120 of the electronic device 104A. Further movement of the electronic device 104A towards the connector module 108, as shown in FIG. 7C, moves the protruding portion 210-1 of the plunger 210 into the connector module housing 202. Such movement of the plunger 210 into the connector module housing 202 causes a corresponding outward movement of the module optical connector 112, as shown in FIG. 7C. The outward movement of the module optical connector 112 causes the protection door 502 to open outwardly (a partial open position is shown in FIG. 7C). The outward opening of the protection door 502 prevents dust or other particles on the outside surface of the protection door 502 from contaminating the module optical connector 112. Finally, in FIG. 7D, the device optical connector 110 has been brought into full engagement with the module optical connector 112, at which point the protection door 502 is in the fully open position.

Although reference has been made to moving an electronic device while maintaining the connector module stationary in the foregoing discussion, it is noted that in alternative examples, an electronic device is maintained stationary while the connector module is moved to engage with the electronic device.

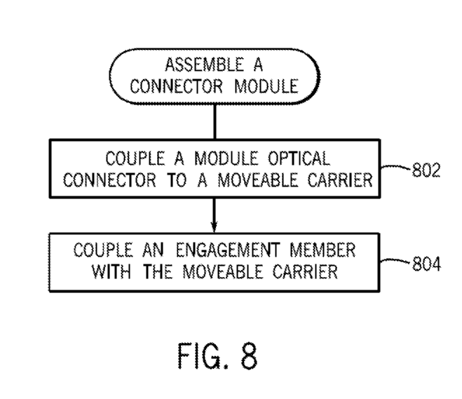

FIG. 8 is a flow diagram of a process of assembling a connector module 108 according to some implementations. The process of FIG. 8 can be performed at a manufacturing facility of the connector module 108, or alternatively, the process of FIG. 8 can be performed by another entity for assembling the connector module 108.

The process includes coupling (at 802) the module optical connector 112 to the moveable carrier 208 of the connector module 108 (see FIG. 2A, 4A, or 4B for example). Next, the process couples (at 804) an engagement member (which can be part of the plunger 210 or 210B shown in FIG. 2A, 4A, or 4B, for example) with the moveable carrier 208. The engagement member (e.g. 210-2 of FIG. 2A or 4A or an engagement member that is part of the plunger 210B of FIG. 4B) is engageable with an actuation feature (a g. alignment feature 216 of FIG. 2A or housing section 120 of FIG. 4A or 48) to cause movement of the moveable carrier 208 to move the module optical connector 112 towards the device optical connector 110.

Using techniques or mechanisms according to some implementations, more reliable blind-mate optical connectors can be provided. Also, since a dampener can be provided to control the mating speed, separate protection elements do not have to be provided for individual ferrules of an optical connector, which allows for an increased density of ferrules in an optical connector. Also, by providing a protection door in some implementations, protection is provided to optical elements of an optical connector to avoid contamination by dust or other particles.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A connector module comprising:
a moveable carrier;
a module optical connector coupled to the moveable carrier; and
an engagement member to engage with an actuation feature of a device having a device optical connector for optical connection to the module optical connector, wherein the engagement member upon engagement with the actuation feature is to cause movement of the moveable carrier to move the module optical connector towards the device optical connector.

2. The connector module of claim 1, further comprising a housing, wherein the module optical connector has a retracted position inside the housing, and an extended position in which at least a portion of the module optical connector protrudes from an opening in the housing.

3. The connector module of claim 1, further comprising a dampener to control movement of the moveable carrier upon engagement of the engagement member with the actuation feature.

4. The connector module of claim 1, wherein the connector module has a longitudinal axis, and wherein the moveable carrier is slideable along the longitudinal axis.

5. The connector module of claim 1, wherein the engagement member protrudes from a first end of the connector module, and wherein the module optical connector is to be moved towards the first end to connect to the device optical connector.

6. The connector module of claim 1, wherein the engagement member is to receive the actuation feature that protrudes outwardly from the device.

7. The connector module of claim 1, further comprising:
a protection door actuatable between a closed position and an open position, wherein the protection door is to cover the module optical connector when in the closed position, and the protection door is to expose the module optical connector when in the open position.

8. The connector module of claim 7, Wherein the protection door is to be actuated from the closed position to the open position as the module optical connector is moved towards the device optical connector.

9. The connector module of claim 1, wherein the engagement member is to engage an alignment profile of the actuation feature of the device to align the module optical connector with respect to the device optical connector.

10. The connector module of claim 1, further comprising:
a rotatable member to be rotated by movement of the engagement member due to engagement to the actuation feature, wherein rotation of the rotatable member causes sliding movement of the moveable carrier.

11. A system comprising:
an electronic device having a device optical connector; and
a connector module having:
an engagement member engageable by the electronic device;
a module optical connector to be moved towards the device optical connector due to movement of the engagement member; and
a dampener to control movement of the module optical connector.

12. The system of claim 11, wherein the connector module further has a moveable carrier coupled to the module optical connector, wherein the moveable carrier is moveable in a first direction in response to movement of the engagement member in a second, opposite direction, and wherein the module optical connector is attached to the moveable carrier.

13. The system of claim 11, further comprising:
a second electronic device having a second device optical connector; and
a second connector module having:
a second engagement member engageable by the second electronic device,
a second module optical connector to be moved towards the second device optical connector due to movement of the second engagement member, and
a dampener to control movement of the second module optical connector.

14. The system of claim 13, further comprising:
a backplane infrastructure, wherein the connector modules are attached to the backplane infrastructure.

15. A method of assembling a connector module, comprising:
coupling a module optical connector to a moveable carrier; and
coupling an engagement member with the moveable carrier, wherein the engagement member is engageable with an actuation feature of a device having a device optical connector, and wherein engagement of the engagement member with the actuation feature is to cause movement of the moveable carrier to move the module optical connector towards the device optical connector.
